(19) United States
(12) Patent Application Publication
(10) Pub. No.: US 2003/0082025 A1
(43) Pub. Date: May 1, 2003

(54) Blind fasteners and installation methods and apparatus

(76) Inventor: Ralph Luhm, La Habra Heights, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/272,574

(22) Filed: Oct. 16, 2002

Related U.S. Application Data
(60) Provisional application No. 60/330,374, filed on Oct. 18, 2001.

(51) Int. Cl. F16B 13/04

(52) U.S. Cl. 411/43

(57) ABSTRACT

Fasteners for fastening adjacent workpieces, and methods and apparatus for installing them. The fasteners include a shank having a head on one end. In one form, the other end may include a counterbore, with the outer end of the counterbore deflected inward to form an inward taper on the end of the shank, facilitating the entry of the shank into the hole in the work pieces. In another form, the other end of the shank may simply be formed with a chamfer. The fasteners also contain a stem having a head located adjacent the blind end of the shank. The stem head is pulled to expand and tightly fasten the shank to the workpieces. While applicable to both temporary fasteners and some permanent fasteners, configurations disclosed particularly for temporary fasteners can allow use of a high strength material for the shank, allowing temporary fastening of larger parts and/or with fewer temporary fasteners than with prior art temporary fasteners.

### CROSS-REFERENCE TO RELATED APPLICATION

This application claims the benefit of U.S. Provisional Patent Application No. 60/330,374 filed on Oct. 18, 2001.

### BACKGROUND OF THE INVENTION

1. Field of the Invention

The present invention relates to blind fasteners for fastening adjacent workpieces.

2. Description of Related Art

Aircraft structures are normally constructed from a number of individual panels that are fastened to a frame by a plurality of rivets. Temporary fasteners are typically installed in a small percentage of fastener holes in adjacent parts to insure that the workpieces do not become separated during the installation of the permanent rivets. The temporary fasteners are each eventually removed and replaced with a permanent rivet once most of the permanent rivets have been installed.

Temporary blind fasteners typically contain a shank that extends through a hole drilled through the workpieces. The shank has a head that prevents the fastener from falling into the “blind” side of the assembly. The fastener also contains a pull stem that has a stem head located at the blind end of the shank. The stem head is pulled through the shank to form some form of bulbous end on the shank, to expand the shank and secure the fastener to the workpieces. The temporary fastener is eventually removed by drilling through the head and the shank with a drill of the proper diameter for the shank of the permanent rivet to be installed. By using a drill that is larger in diameter than the shank head, and preferably with a conical shank head, the shank head can be entirely removed by the drill, eliminating what are referred to a spinners, namely shank head remnants that are grabbed by the drill to rotate therewith to scratch the surface of the work pieces or to build up on the drill itself. Temporary fasteners of the foregoing type are disclosed in U.S. Pat. No. 5,689,873 owned by the assignee of the present invention.

Temporary fasteners of the foregoing type have also used shanks of high strength materials. In the configuration of the above referenced patent, there is a tendency for the blind end of a high strength material shank to split on pulling of the stem. However by putting a counterbore in the blind end of the shank, the splitting was avoided. Tacking fasteners of this type have been successfully used commercially. However, with whichever prior art configuration is used, the outer diameter of the blind end of the stem is nearly equal to the diameter of the hole in the workpiece, making insertion of the temporary fasteners into the holes a somewhat exacting process. If anything, the temporary fasteners with the counterbored stems probably have a slightly larger blind end, toward the upper tolerance limit, because of the counterbore being put in on a header machine, not cut in.

Some areas of the aircraft are not fully accessible, thereby requiring the use of a blind rivet that can be installed from only one side of a workpiece. In these areas, permanent blind fasteners are ultimately used. Such fasteners typically have a shank with a head on one end, and a pull stem extending through the shank and head with some form of shank tail-former on the distal end of the stem for forming some form of bulbous end on the shank during pulling. These permanent fasteners are generally designed to cause stem fracturing at a predetermined position on the stem during pulling once the distal end of the shank is formed and the stem portion in the shank is locked to the shank. Such fasteners may be made leak free, and are commonly used for such things as fuel tank construction.

Automatic blind rivet guns that can be used to install blind rivets, including both temporary and permanent fasteners of the foregoing type, are also known. Such guns automatically load each fastener into the pulling head in the gun, so the fasteners can't be put into the holes in the workpieces before the stem is inserted into the pulling head. Because of the speed with which these guns can potentially operate, time spent trying to find each hole with a fastener in the pulling head would grossly slow down the potentially quick fastener installation process.

### BRIEF SUMMARY OF THE INVENTION

Fasteners for fastening adjacent workpieces, and methods and apparatus for installing them. The fasteners include a shank having a head on one end. In one form, the other end may include a counterbore, with the outer end of the counterbore deflected inward to form an inward taper on the end of the shank, facilitating the entry of the shank into the hole in the work pieces. In another form, the other end of the shank may simply be formed with a chamfer. The fasteners also contain a stem having a head located adjacent the blind end of the shank. The stem head is pulled to expand and tightly fasten the shank to the workpieces. While applicable to both temporary fasteners and some permanent fasteners, configurations disclosed particularly for temporary fasteners can allow use of a high strength material for the shank, allowing temporary fastening of larger parts and/or with fewer temporary fasteners than with prior art temporary fasteners.

### BRIEF DESCRIPTION OF THE DRAWINGS

FIG. 1 is a view of one embodiment of the present invention.

FIG. 2 is a view of an alternate shank head shape for one embodiment of the present invention.

FIG. 3 is a view of a further alternate shank head shape for one embodiment of the present invention.

FIG. 4 is a view of a still further alternate shank head shape for one embodiment of the present invention.

FIGS. 5, 6 and 7 are cross sections illustrating an exemplary process for forming the fastener shank from cylindrical slug to finish formed shank and shank head using a three blow header.

FIGS. 8, 9 and 10 are cross sections illustrating the operation of the third die in the exemplary shank and shank head forming process.

FIG. 11 is an illustration of a typical stem used with one embodiment of the present invention.

FIG. 12 is a drawing illustrating the use of an automatic rivet gun for the installation of fasteners of the present invention.

FIG. 13 is a cross section of a set fastener in accordance with one embodiment of the present invention.

FIG. 14 is a partial cross section representative of A code and Dash code fasteners incorporating the present invention.

FIGS. 15 and 16 are views of carriers with the temporary fasteners of FIG. 1 mounted therein for use in an automatic rivet gun.

### DETAILED DESCRIPTION OF THE PREFERRED EMBODIMENT

The present invention is applicable to temporary fasteners as well as some permanent fasteners, and is also applicable to fasteners mounted in carriers as may be used in automatic blind fastener setting guns. Accordingly, first the application of the present invention to temporary fasteners will be discussed, followed by permanent fasteners and then as it applies to fastener carriers used in automatic installation guns.

Temporary Blind Fasteners

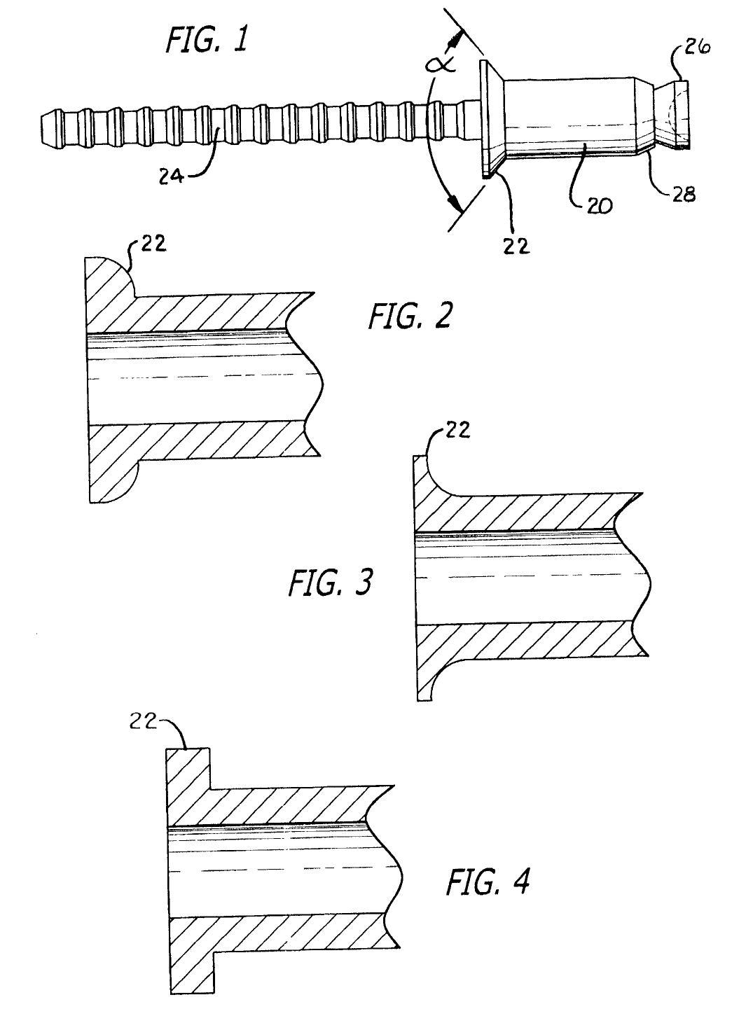

First referring to FIGS. 1 through 4, exemplary embodiments of the present invention may be seen. As shown therein, the tacking fastener or rivet is characterized by a sleeve having a shank portion 20 and a shank head 22, with a pulling stem having a pulling portion 24 extending from the sleeve head, and a stem head or tail former 26 at the distal end of shank 20. The rivet is also characterized by a taper 28 at the distal end of the shank 20, details of which will be subsequently described.

One of the aspects of the present invention is the possible use of a high strength alloy, and particularly a high strength aluminum alloy, for the sleeve comprising shank 20 and head 22. The use of a high strength alloy provides a higher strength temporary fastener, in some applications allowing fewer temporary fasteners to be used and/or larger or heavier parts to be joined, resulting in reduced manufacturing costs of structures such as aircraft structures. High strength materials as used herein means materials having a shear strength of over about 38,000 psi. Suitable high strength aluminum alloys include, but are not limited to, 7050 T73 and 2017 T4 aluminum alloys. Alternatively, lower strength materials may be used, such materials including but not being limited to 2117 T4 and 5056-O aluminum alloys.

In the embodiment shown in FIG. 1, the shank head 22 has a conical shape, preferably with an included angle α less than the included angle on the drill that will be used to drill out the temporary fastener once the permanent fasteners have been installed in adjacent holes in the workpieces. By proper selection of the size of the temporary fastener, and particularly the outer diameter of the head 22 of the temporary fasteners used for a particular application, a drill having a diameter larger than the diameter of the head 22 on the temporary fastener may be used. This allows the drill to remove all or substantially all of the material of the fastener head before starting to enlarge the hole in the first workpiece. The conical head also better centers the temporary fastener in the hole and minimizes the amount of material to be removed by the drill.

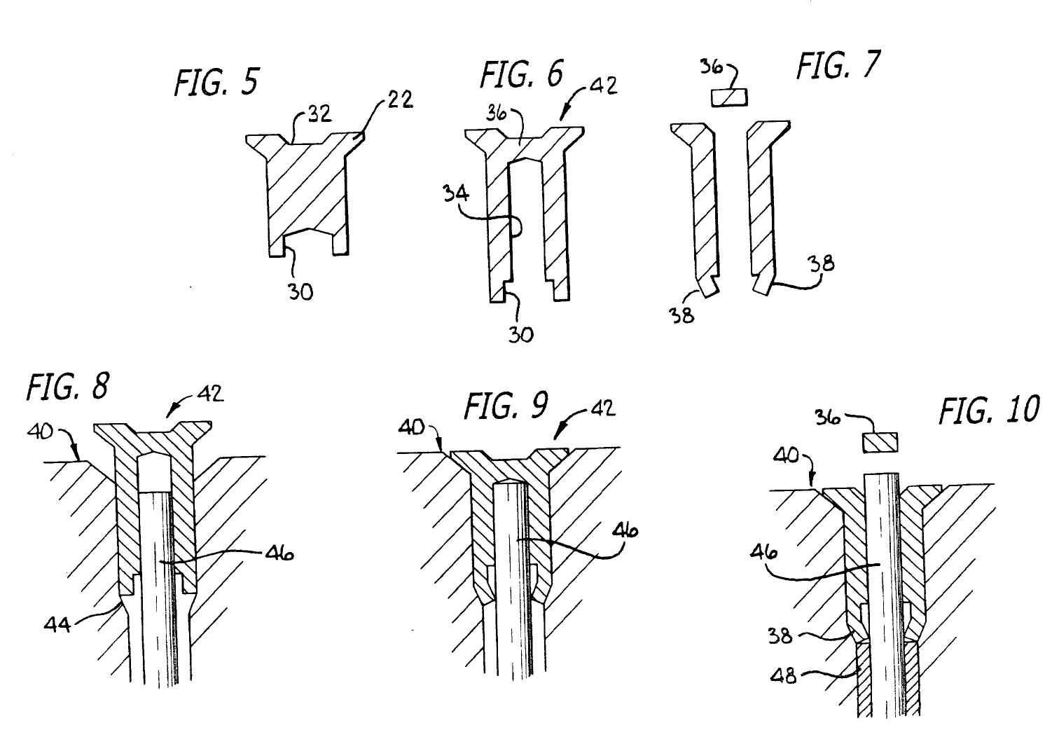

Exemplary alternate embodiments of temporary fasteners in accordance with the present invention may be seen in FIGS. 2, 3 and 4. In the embodiment shown in FIG. 2, the head 22 is a convex head, such as a section of a sphere, whereas in the embodiment of FIG. 3, the head has a concave shape where it joins the shank of the temporary fastener. These head shapes, like a conical shape, help center the fastener in the hole in the workpieces. In the embodiment shown in FIG. 4, the head 22 is a generally cylindrical head. While this, and still other head configurations may be used in the present invention, the same are generally not preferred. In particular, when a cylindrical head is drilled out using a drill larger than the head, a ring of head material remains when the drill intersects the top of the hole in the outer workpiece, freeing the ring from the shank 20 of the fastener sleeve. This may allow the remaining ring to spin with the drill, thereby acting as a thrust bearing, preventing the drill from further progress in the drill-out. Such spinners, at a minimum, add time to the drill-out process. In addition, they are likely to scratch the surface of the outer work piece and may result in the drill tending to walk, resulting in further undesired consequences. While the use of high strength materials for the fastener sleeve would be expected to increase the probability of spinners, head shapes other than conical may be used with the present invention, as the sharp edge of a drill point may cut through any remaining ring, particularly for the smaller size temporary fasteners that may be used. Of course, not all embodiments use the higher strength materials. For the preferred embodiment of temporary fasteners, the sleeve of the temporary fastener is formed on a three-blow header from a slug of the appropriate high strength material cut from a wire or rod of appropriate diameter. In the first die, the slug is upset as shown in FIG. 5 to form the sleeve head 22 and the counterbore 30. (The word counterbore as used herein and in the following claims is used in the general sense to refer to a cylindrical enlargement of the mouth of a hole, and not in the more narrow sense of necessarily implying a flat bottom hole, or a method of forming, such as by boring.) In the preferred embodiment, a depression 32 is also formed in the sleeve head 22 to provide a more substantial centering of the drill during the initiation of the drill-out process for removal of the temporary fastener. In the second die (FIG. 6), the sleeve is extruded to form the inner cylindrical surface 34 of the sleeve extending along most of the length thereof. The diameter of the surface 34 is smaller than the diameter of the counterbore 30, leaving the counterbore substantially unaffected. Then, in the third die, the center slug region 36 is punched out (see FIGS. 6 and 7) and the end of the sleeve 38 in the counterbored region is deflected inward to provide a taper on the blind end of the sleeve of the temporary fastener.

FIGS. 8, 9 and 10 schematically show the functional details of the third die of the preferred embodiment. The die, generally indicated by the numeral 40, has a countersunk face with a cavity into which the partially formed fastener shank 42 slides (see also FIG. 6). The die 40 in the preferred embodiment is mounted with a relatively stiff spring mount, being held in the positions schematically shown in FIGS. 8 and 9 by the spring, though being deflectable by the header hammer as shown in FIG. 10. The cavity in the die tapers inward in region 44 with a stationary pin 46 extending therethrough. As the hammer (not shown) extends to contact the face of the die, the partially formed shank 42 is forced into the die cavity as shown in FIG. 9, deflecting the chamfered region on the distal end or blind end of the shank inward to form a taper thereon. Then on further progression of the hammer, the die is deflected against its spring mount so that the stationary pin 46 punches slug 36 out of the center of the head region of the shank to complete the formation thereof. Then after withdrawal of the hammer, an ejection sleeve 48 (FIG. 10) is extended to eject the sleeve from the die.

The foregoing die set and sleeve forming operations are exemplary only, as other die sets and forming operation sequences may readily be used as desired by those skilled in the art. By way of example, on a four-blow header, the third operation might punch out slug 36 only, or form the tapered end 38 on the sleeve, with the remaining operation being accomplished in the fourth header die. Whatever sequence is used, however, it is preferable in many cases to form the chamfer 38 on the distal end of the sleeve prior to the final heat treat of the sleeve. Otherwise the work hardening resulting from the formation of the chamfered area will remain on the finished part, which may affect the pulling characteristics of the temporary fasteners and which may result in the undesired splitting of the blind end of the sleeve during pulling, at least for the high strength materials. The heat treat for the exemplary materials are as follows:

| | |
|---|---|
| 7050 T73 | Solution treat and duplex age |
| 2017 T4 | Solution treat and room temperature age harden |
| 2117 T4 | Solution treat and room temperature age harden |
| 5056-O | Anneal |

As an alternative, the first or second dies, or both, may be configured to form the chamfer on the slug as it is being processed, in which case the internal diameter of the counterbore will remain cylindrical, rather than being deflected inward as shown in FIG. 7. This is not preferred, however, as it would make the very distal end of the sleeve quite thin or sharp, which could cause radial wandering of the head of the stem on initial pulling thereof and/or splitting of the distal end on pulling of the fastener.

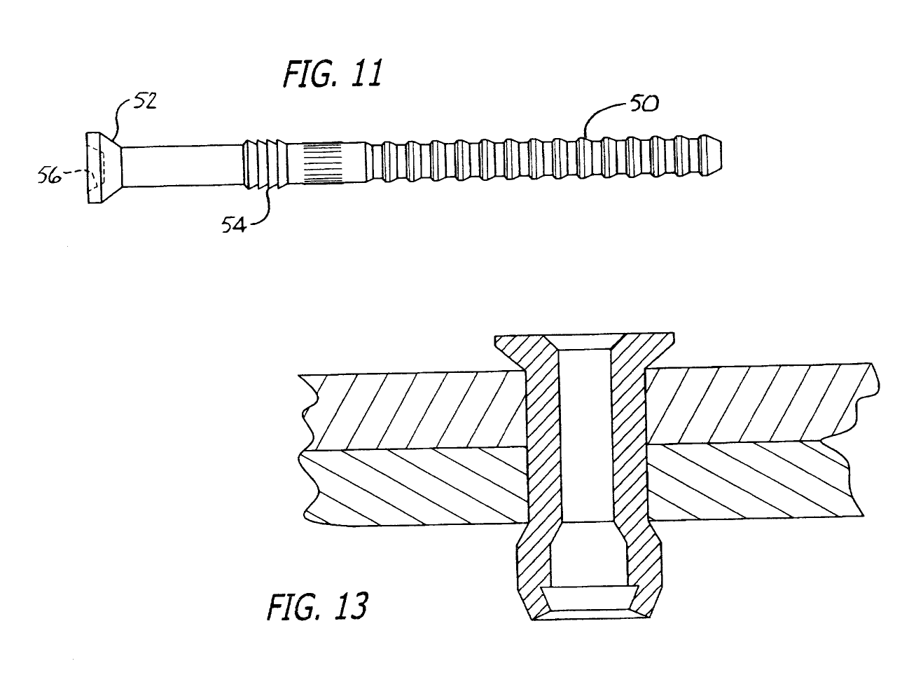

A typical stem used with the temporary fasteners of the present invention may be seen in FIG. 11. Such a stem will typically have a gripping portion 50 and a collapsible head 52. There will also normally be some provision for maintaining the stems and sleeves in the assembled condition, frequently by some provision in region 54 of the stem of FIG. 11, as is well known in the art. The characteristics of the collapsing head 52 are generally controlled by the extent of the recess 56 formed in the head end of the stem.

The outer diameter of the collapsible head on the stem will normally be significantly smaller than the outer diameter of the temporary fastener shank. Consequently, the chamfered or tapered blind end on the shank makes placement of the temporary fasteners into the holes in the workpieces much easier than in the prior art. In particular, in the prior art, without the taper or chamfer, the temporary fastener had to be quite accurately centered on (and perpendicular to) the hole in the workpieces for the fastener to go into position for pulling. Because of this, many installers of such fasteners will place a fastener into the hole in the workpieces before gripping the stem with the pulling tool. This way, the pulling tool does not obstruct the installer's view of the fastener relative to the center of the hole. The present invention however, not only allows use of high strength materials for the fastener, but also substantially speeds up the installation process, whether the fastener is first placed into the gripping head in the pulling tool, or first placed into the hole in the workpieces.

Permanent Blind Fasteners

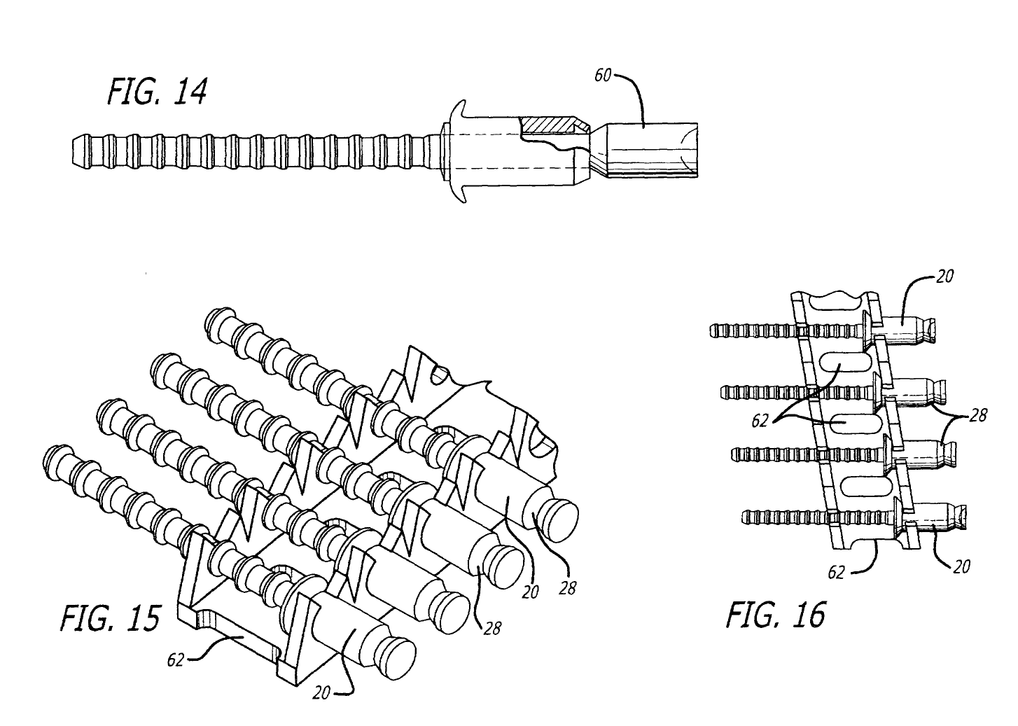

The present invention may be used with some permanent blind fasteners when the incorporation of the invention does not effect the function or strength of the fastener. Such fasteners include fasteners of the wiredraw type, wherein the stem head reduces in diameter during drawing much like a wire being pulled through a reducing die. Fasteners of this type include fasteners referred to as “A” and “dash code” fasteners. A dash code fastener uses a double action pulling process wherein the second action locks the remaining stem portion in place prior to the stem fracturing, whereas an A code fastener uses a single stem pull to set the fastener and lock the remaining portion of the stem in place. Prior art fasteners of this type as made by Allfast Fastening Systems, Inc., assignee of the present invention, already have a counterbore on the end of the shank to prevent splitting of the shank on setting of the fastener. Consequently, the counterbore region may be formed inward to achieve the desired purpose, as illustrated in FIG. 14. In that regard, these fasteners typically have a stem head diameter of approximately 90% of the shank diameter, and forming the end of the shank inward to a diameter much less than the stem head diameter may not be particularly useful. Still, a small taper or chamfer on the end of the shank down to approximately equal to the stem head diameter is quite effective, as even a small chamfer makes finding the hole in the workpiece much easier.

Automatic Installation Guns and Fastener Carriers

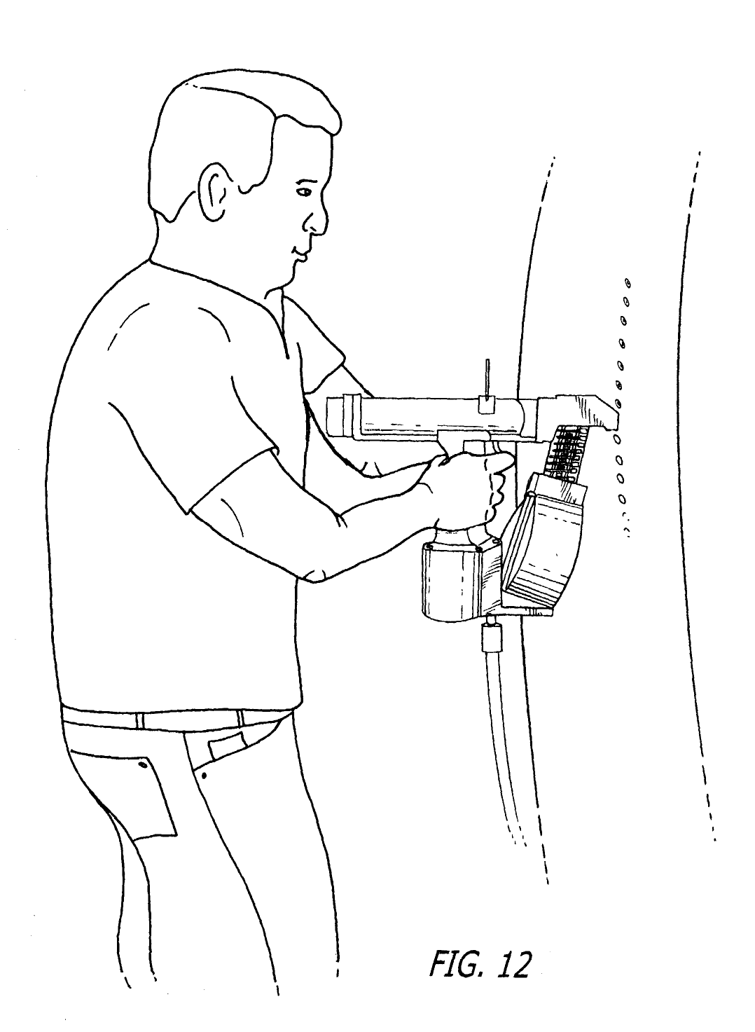

Automatic rivet guns of various types are also known in the prior art. Some of these guns have a stationary rivet feeding unit connected to the pulling gun through an umbilical chord supplying the rivets to the gun, such as the Tackmatic rivet installation system sold by Allfast Fastening Systems, Inc., assignee of the present invention. Other guns are known that use some form of magazine on the rivet gun itself to automatically supply rivets to the pulling head. Such guns include those described in U.S. Pat. Nos. 5,544,407 and 5,651,169, and disclosed in co-pending U.S. patent application Ser. No. 09/815,601, entitled “Rivet Gun,” and assigned to the assignee of the present invention, the disclosure of which is hereby incorporated by reference. Such guns further speed up the installation process, though because the fasteners are automatically fed to the pulling head, the placement of the fastener into the hole in the workpieces before placement of the fastener stem into the pulling head is not an option. Consequently finding the holes with the fastener already in the pulling head and somewhat obstructed by the gun may be the most time consuming aspect of using such guns. The present invention however, provides a solution to that problem, reducing the time required to find the hole, so to speak, as well as potentially providing a high strength fastener for temporarily joining larger parts than conventional temporary fasteners. Accordingly, use of the present invention in automatic rivet guns, such as illustrated in FIG. 12, is a contemplated use of the present invention. In that regard, as may be seen in FIGS. 15 and 16, the taper or chamfer 28 (see FIG. 1 also) on the end of the shank 20 in accordance with the present invention does not effect or interfere with the mounting of the fasteners on carriers of the general type that are typically used with such guns, such as carrier 62. Fasteners in such carriers may be aligned perpendicular to the longitudinal axis of the carrier as in FIG. 15, or angled with respect to the carrier longitudinal axis, as shown on FIG. 16.

The fasteners of the present invention are set in the same manner as temporary or permanent fasteners of the prior art, namely by placing the shank of the fastener in the hole in the work pieces with the shank head contacting the surface of the outer workpiece, and then pulling the stem relative to the shank head. In the case of permanent fasteners, the stem head causes the distal end of the shank to bulge or form outward to set the fastener, after which the stem fractures at a predetermined location with the part of the stem remaining in the shank being locked therein. In the case of temporary fasteners, the stem and stem head is pulled entirely through the shank and shank head. In so doing, the head on the stem expands the uncounterbored blind end of the shank to a diameter larger than the hole in the workpieces, and expands the part of the shank within the hole in the workpieces to a tight fit within the hole, after which the head of the stem will collapse as necessary for the head to pass through the rest of the shank and shank head. The set fastener appears in cross section as shown in FIG. 13. As shown therein, in the preferred embodiment, the distal part of the blind end of the shank having the counterbore thereon typically does not expand as much as the rest of the shank, leaving a tapered or chamfered appearance in the distal end of the set fastener. In the case of some materials, mainly the lower strength materials, the counterbore in the distal end of the shank is not required, but rather is optional. If not used, the inner diameter of the very distal tapered end of the shank would be expected to expand on pulling as much as in the rest of the free part of the shank. As may be seen in this Figure, in the setting of temporary fasteners, the stem is generally pulled entirely through the sleeve of the fastener, leaving only the sleeve in the workpieces.

While preferred embodiments of the present invention have been disclosed herein, such disclosure is only for purposes of understanding exemplary embodiments and not by way of limitation of the invention. It will be obvious to those skilled in the art that various changes in form and detail may be made in the invention without departing from the spirit and scope of the invention as set out in the full scope of the following claims.

What is claimed is:

1. In combination:
a fastener carrier adapted for use in a fastener gun for the automatic sequential loading of tacking fasteners into a pulling head of the gun;
a plurality of fasteners retained in the fastener carrier in parallel disposition with respect to each other, each fastener having;
a shank having an outer diameter and an inner diameter, a first end, a second end and a shank head extending from the first end;
a stem extending through said inner diameter of said shank and having a head located adjacent to said second end of said shank, the head on the stem having an outer diameter less than the outer diameter of the shank;
the tacking fastener being configured for the stem to pull entirely through the shank on setting of the fastener;
the shank having a counterbore at its second end;
the portion of the shank having the counterbore being deflected inward to define a tapered outer diameter of the shank in the region of the counterbore to a minimum outer diameter at the second end of the shank.

2. The combination of claim 1 wherein the plurality of fasteners are retained in the fastener carrier with a fastener axis that is not perpendicular to a longitudinal axis of the carrier.

3. In combination:
a fastener carrier adapted for use in a fastener gun for the automatic sequential loading of tacking fasteners into a pulling head of the gun;
a plurality of fasteners retained in the fastener carrier in parallel disposition with respect to each other, each fastener having;
a shank having an outer diameter and an inner diameter, a first end, a second end and a shank head extending from the first end;
a stem extending through said inner diameter of said shank and having a head located adjacent to said second end of said shank, the head on the stem having an outer diameter less than the outer diameter of the shank;
the tacking fastener being configured for the stem to pull entirely through the shank on setting of the fastener;
the second end of the shank being tapered.

4. The combination of claim 3 wherein the plurality of fasteners are retained in the fastener carrier with a fastener axis that is not perpendicular to a longitudinal axis of the carrier.

5. In combination:
a fastener carrier adapted for use in a fastener gun for the automatic sequential loading of fasteners into a pulling head of the gun;
a plurality of fasteners retained in the fastener carrier in parallel disposition with respect to each other, each fastener having;
a shank having an outer diameter and an inner diameter, a first end, a second end and a shank head extending from the first end;
a stem extending through said inner diameter of said shank and having a head located adjacent to said second end of said shank, the head on the stem having an outer diameter less than the outer diameter of the shank;
the fastener being configured for the stem, on setting of the fastener, to form a bulbous end on the shank and then fracture, leaving a predetermined portion of the stem locked in the set fastener;
the shank having a counterbore at its second end;
the portion of the shank having the counterbore being deflected inward to define a tapered outer diameter of the shank in the region of the counterbore to a minimum outer diameter at the second end of the shank.

6. The combination of claim 5 wherein the plurality of fasteners are retained in the fastener carrier with a fastener axis that is not perpendicular to a longitudinal axis of the carrier.

7. In combination:
a fastener carrier adapted for use in a fastener gun for the automatic sequential loading of fasteners into a pulling head of the gun;
a plurality of fasteners retained in the fastener carrier in parallel disposition with respect to each other, each fastener having;
a shank having an outer diameter and an inner diameter, a first end, a second end and a shank head extending from the first end;
a stem extending through said inner diameter of said shank and having a head located adjacent to said second end of said shank, the head on the stem having an outer diameter less than the outer diameter of the shank;
is the fastener being configured for the stem, on setting of the fastener, to form a bulbous end on the shank and then fracture, leaving a predetermined portion of the stem locked in the set fastener;
the second end of the shank being tapered.

8. The combination of claim 7 wherein the plurality of fasteners are retained in the fastener carrier with a fastener axis that is not perpendicular to a longitudinal axis of the carrier.

9. A tacking fastener comprising:
a shank having an outer diameter and an inner diameter, a first end, a second end and a shank head extending from the first end;
a stem extending through said inner diameter of said shank and having a head located adjacent to said second end of said shank, the head on the stem having an outer diameter less than the outer diameter of the shank;
the tacking fastener being configured for the stem to pull entirely through the shank on setting of the fastener;
the shank having a counterbore at its second end;
the portion of the shank having the counterbore being deflected inward to define a tapered outer diameter of the shank in the region of the counterbore to a minimum outer diameter at the second end of the shank.

10. The tacking fastener of claim 9 wherein the outer diameter of the portion of the shank having the counterbore is conical to the minimum outer diameter at the second end of the shank.

11. The tacking fastener of claim 9 wherein the minimum outer diameter is approximately equal to the outer diameter of the head on the stem.

12. The tacking fastener of claim 9 wherein the inner diameter of the portion of the shank having the counterbore is not less than the inner diameter of the portion of the shank adjacent to the counterbore.

13. The tacking fastener of claim 9 wherein the shank has a shear strength of over 38,000 psi.

14. The tacking fastener of claim 13 wherein the shank is aluminum alloy selected from the group consisting of 7050 T73 and 2017 T4 aluminum alloys.

15. The tacking fastener of claim 9 wherein the shank is aluminum alloy selected from the group consisting of 2117 T4 and 5056-O aluminum alloys.

16. A tacking fastener comprising:
a shank having an outer diameter and an inner diameter, a first end, a second end and a shank head extending from the first end;
a stem extending through said inner diameter of said shank and having a head located adjacent to said second end of said shank, the head on the stem having an outer diameter less than the outer diameter of the shank;
the tacking fastener being configured for the stem to pull entirely through the shank on setting of the fastener;
the second end of the shank being tapered.

17. The tacking fastener of claim 16 wherein the minimum outer diameter of the tapered region is approximately equal to the outer diameter of the head on the stem.

18. The tacking fastener of claim 17 wherein the shank has a shear strength of over 38,000 psi.

19. The tacking fastener of claim 18 wherein the shank is aluminum alloy selected from the group consisting of 7050 T73 and 2017 T4 aluminum alloys.

20. The tacking fastener of claim 17 wherein the shank is aluminum alloy selected from the group consisting of 2117 T4 and 5056-O aluminum alloys.

21. A fastener comprising:
a shank having an outer diameter and an inner diameter, a first end, a second end and a shank head extending from the first end;
a stem extending through said inner diameter of said shank and having a head located adjacent to said second end of said shank, the head on the stem having an outer diameter less than the outer diameter of the shank;
the fastener being configured for the stem, on setting of the fastener, to form a bulbous end on the shank and then fracture, leaving a predetermined portion of the stem locked in the set fastener;
the shank having a counterbore at its second end;
the portion of the shank having the counterbore being deflected inward to define a tapered outer diameter of the shank in the region of the counterbore to a minimum outer diameter at the second end of the shank.

22. The fastener of claim 21 wherein the outer diameter of the portion of the shank having the counterbore is conical to the minimum outer diameter at the second end of the shank.

23. The fastener of claim 21 wherein the minimum outer diameter is approximately equal to the outer diameter of the head on the stem.

24. The fastener of claim 21 wherein the inner diameter of the portion of the shank having the counterbore is not less than the inner diameter of the portion of the shank adjacent to the counterbore.

25. The fastener of claim 21 wherein the fastener is an A code fastener.

26. The fastener of claim 21 wherein the fastener is a dash code fastener.

27. A fastener comprising:
a shank having an outer diameter and an inner diameter, a first end, a second end and a shank head extending from the first end;
a stem extending through said inner diameter of said shank and having a head located adjacent to said second end of said shank, the head on the stem having an outer diameter less than the outer diameter of the shank;
the fastener being configured for the stem, on setting of the fastener, to form a bulbous end on the shank and then fracture, leaving a predetermined portion of the stem locked in the set fastener;
the second end of the shank being tapered.
